(19) United States
(12) Patent Application Publication
(10) Pub. No.: US 2003/0169558 A1
(43) Pub. Date: Sep. 11, 2003

(54) Multi-function carbon composite capacitor electrode

(76) Inventors: John B. Olson, Boulder, CO (US); Timothy L. Feaver, Louisville, CO (US); Philip C. Lyman, Boulder, CO (US)

Correspondence Address: THE LAW OFFICES OF WILLIAM W. COCHRAN, LLC, 3555 STANFORD ROAD, SUITE 230, FORT COLLINS, CO, 80525, US

(21) Appl. No.: 10/387,202

(22) Filed: Mar. 10, 2003

Related U.S. Application Data
(60) Provisional application No. 60/362,841, filed on Mar. 11, 2002.

(51) Int. Cl. H01G 9/00

(52) U.S. Cl. 361/502

(57) ABSTRACT

An ultracapacitor is manufactured from a woven carbon fiber material that is partially saturated with structural resin. The portion of the carbon fiber material that contains the resin may be used as a structural element in spacecraft or other applications. The carbon fibers of the woven material are used both as the current collector and the electrode. Activated carbon fiber material may be used or only the electrode portion of the carbon fibers may be activated.

### CROSS REFERENCE TO RELATED APPLICATIONS

This application is based upon and claims the benefit of U.S. provisional application No. 60/362,841 entitled “Multi-Function Carbon Composite Capacitor Electrode”, filed Mar. 11, 2002 by John B. Olson, et al, the entire disclosure of which is herein specifically incorporated by reference for all that it discloses and teaches.

### BACKGROUND OF THE INVENTION

a. Field of the Invention

The present invention pertains to capacitors and specifically to ultracapacitors using carbon fiber as an electrically conductive medium.

b. Description of the Background

Ultracapacitors have a very high electrode surface area compared to conventional electrolytic capacitors. Thus, ultracapacitors may be constructed that have very large energy capacities compared to conventional electrolytic capacitates. A typical medium for ultracapacitors may be activated carbon, since activated carbon is conductive and has extremely large surface area per volume of material. Ultracapacitors may also be known as supercapacitors, electromechanical capacitors, double-layer capacitors, and other terms.

One problem with ultracapacitors is the high heat that can be generated by charging or discharging the device. Any inefficiency of the capacitor creates heat that must be dissipated. With the large amounts of energy that may be stored in ultracapacitors, the amount of heat may be very significant.

In applications such as spacecraft or aircraft, the weight of various components can be problematic. Many functional components such as capacitors must be attached to a structural element and otherwise provide no structural strength to the vehicle. Such an ultracapacitor may be found in U.S. Pat. No. 5,793,603.

It would therefore be advantageous to provide an ultracapacitor that provided some structural benefit. It would be further advantageous to provide an ultracapacitor in a manner that heat transfer is efficient while maintaining high performance.

### SUMMARY OF THE INVENTION

The present invention overcomes the disadvantages and limitations of the prior art by providing a system and method for storing energy in an ultracapacitor comprised of a woven carbon fiber electrode. The carbon fiber material is partially saturated with a structural resin so that the rigid portion of the material is available as a current collector and the unsaturated portion is available as an electrode. Further, the rigid portion may be utilized as a mechanical load bearing structure.

The present invention may therefore comprise a method for manufacturing an electrode comprising: providing a woven carbon fiber fabric; saturating a portion of the thickness of the fabric to produce a saturated portion and an unsaturated portion, the saturated portion having at least some structural rigidity and the unsaturated portion having at least some exposed fibers; and attaching an electrical conductor to the saturated portion.

The present invention may further comprise a method for manufacturing an ultracapacitor comprising: providing a first woven carbon fiber fabric; providing a second woven carbon fiber fabric; saturating a portion of the thickness of the first fabric to produce a saturated portion and an unsaturated portion, the saturated portion having at least some structural rigidity and the unsaturated portion having at least some exposed fibers; saturating a portion of the thickness of the second fabric to produce a saturated portion and an unsaturated portion, the saturated portion having at least some structural rigidity and the unsaturated portion having at least some exposed fibers; attaching a first electrical conductor to the saturated portion of the first fabric; attaching a second electrical conductor to the saturated portion of the second fabric; providing a separator material having a first side and a second side; placing the unsaturated portion of the first fabric against the first side of the separator material; placing the unsaturated portion of the second fabric against the second side of the separator material; adding an electrolyte to the unsaturated portion of the first material; adding an electrolyte to the unsaturated portion of the second material; and sealing the saturated portion of the first fabric to the saturated portion of the second fabric.

The present invention may further comprise an electrode manufactured by the method of: providing a woven carbon fiber fabric; saturating a portion of the thickness of the fabric to produce a saturated portion and an unsaturated portion, the saturated portion having at least some structural rigidity and the unsaturated portion having at least some exposed fibers; and attaching an electrical conductor to the saturated portion.

The present invention may further comprise an ultracapacitor manufactured by the method of: providing a first woven carbon fiber fabric; providing a second woven carbon fiber fabric; saturating a portion of the thickness of the first fabric to produce a saturated portion and an unsaturated portion, the saturated portion having at least some structural rigidity and the unsaturated portion having at least some exposed fibers; saturating a portion of the thickness of the second fabric to produce a saturated portion and an unsaturated portion, the saturated portion having at least some structural rigidity and the unsaturated portion having at least some exposed fibers; attaching a first electrical conductor to the saturated portion of the first fabric; attaching a second electrical conductor to the saturated portion of the second fabric; providing a separator material having a first side and a second side; placing the unsaturated portion of the first fabric against the first side of the separator material; placing the unsaturated portion of the second fabric against the second side of the separator material; adding an electrolyte to the unsaturated portion of the first material; adding an electrolyte to the unsaturated portion of the second material; and sealing the saturated portion of the first fabric to the saturated portion of the second fabric.

The present invention may further comprise an electrode comprising: a woven carbon fiber fabric; a resin partially saturated into a portion of the thickness of the fabric to produce a saturated portion and an unsaturated portion, the saturated portion having at least some structural rigidity and the unsaturated portion having at least some exposed fibers; and an electrical conductor attached to the saturated portion.

The present invention may further comprise an ultracapacitor comprising: a first woven carbon fiber fabric; a second woven carbon fiber fabric; a resin partially saturated into a portion of the thickness of the first fabric to produce a saturated portion and an unsaturated portion, the saturated portion having at least some structural rigidity and the unsaturated portion having at least some exposed fibers, the resin further partially saturating a portion of the thickness of the second fabric to produce a saturated portion and an unsaturated portion, the saturated portion having at least some structural rigidity and the unsaturated portion having at least some exposed fibers; a first electrical conductor attached to the saturated portion of the first fabric; a second electrical conductor attached to the saturated portion of the second fabric; a separator material having a first side and a second side, the unsaturated portion of the first fabric being against the first side of the separator material and the unsaturated portion of the second fabric against the second side of the separator material; an electrolyte saturating the unsaturated portion of the first material and saturating the unsaturated portion of the second material; and a sealant sealing the saturated portion of the first fabric to the saturated portion of the second fabric.

The advantages of the present invention are that an ultracapacitor may become both an energy storage device and structural element. Further, heat dissipation may be accomplished through several different mechanisms that are suited for space or terrestrial applications. Many structural elements may be manufactured wherein the capacitor comprises a portion of the mechanical load bearing structure.

The carbon fabric electrode has high surface area, allows electric current collection, provides structural rigidity, and facilitates heat transfer. The individual carbon fibers are bonded to each other in the saturated portion with epoxy or resin material such that the electrode becomes a structural carbon composite. The unbonded carbon fibers provide a high surface as an electrode. In both regions, the carbon fibers offer electrical and thermal conductivity along their lengths.

Several structural elements may be formed with the capacitor. Elements may be designed to facilitate heat transfer as well as to handle structural loads. Such elements include forming corrugated members from the capacitors, incorporating the capacitors as skins on a honeycomb core, or other structural elements.

### BRIEF DESCRIPTION OF THE DRAWINGS

In the drawings,

FIG. 1 is a cross sectional illustration of an embodiment of the present invention of a partially saturated carbon composite electrode.

FIG. 2 is a cross sectional illustration of an embodiment of the present invention of a partially saturated carbon composite electrode with porous carbon bound to the unsaturated portion of the fabric and a conductor.

FIG. 3 is a cross sectional illustration of an embodiment of the present invention of an ultracapacitor.

FIG. 4 is an illustration of an embodiment of the present invention of a structural element comprised of two face sheets and several ultracapacitors.

FIG. 5 is an illustration of an embodiment of the present invention of a structural panel comprised of two face sheets and a corrugated ultracapacitor.

### DETAILED DESCRIPTION OF THE INVENTION

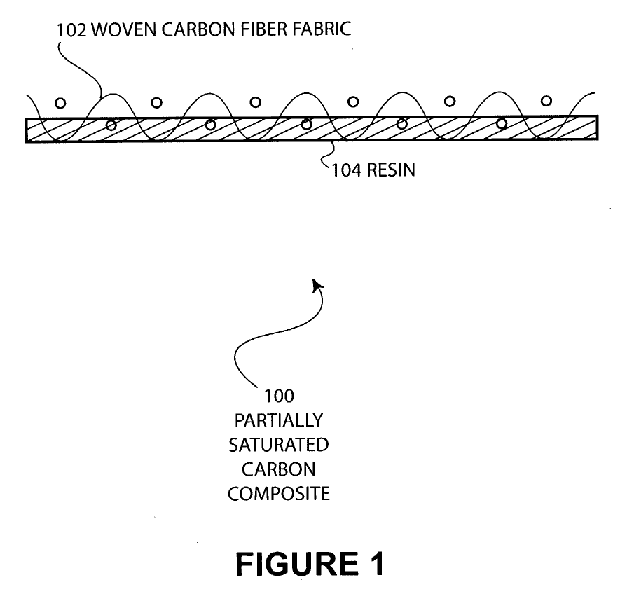

FIG. 1 illustrates a cross sectional view of an embodiment 100 of the present invention of a partially saturated carbon composite electrode. A woven carbon fiber fabric 102 is partially saturated with resin 104.

The woven carbon fiber fabric 102 may be any type of pattern, such as plain, twill, satin, and others. The carbon fibers may be of any type of carbon fiber. The resin 104 may be a thermoset resin, epoxy resin, thermoplastic resin, or any other resin material. Typical resins that are well known for carbon composite structures may be used.

The woven carbon fiber fabric 102 is partially saturated with resin 104. The portion of the fabric that is saturated with resin may have some structural rigidity as well as being conductive. The portion of the fabric 102 that does not contain resin may be used for the electrode portion of a capacitor as described hereinafter.

In some embodiments, the carbon fibers may be activated. Activation of the fibers drastically increases the surface area of the carbon fibers, increasing the performance of a capacitor constructed of the same. For example, the woven carbon fiber fabric 102 may be activated by heating the fabric 102 to an activation temperature. In another example, the fabric 102 may be woven from carbon fibers that are already activated. In still another example, only the non-resin impregnated portion of the embodiment 100 may be activated by heating the exposed carbon fiber fabric. Various methods may be used to activate the carbon fibers while keeping within the spirit and intent of the present invention.

The resin 104 may have additives that may enhance conductivity. For example, silver, activated carbon, aluminum, copper, or other conductive additives may be incorporated into the resin 104. Such additives may increase the electrical performance of the electrode 100.

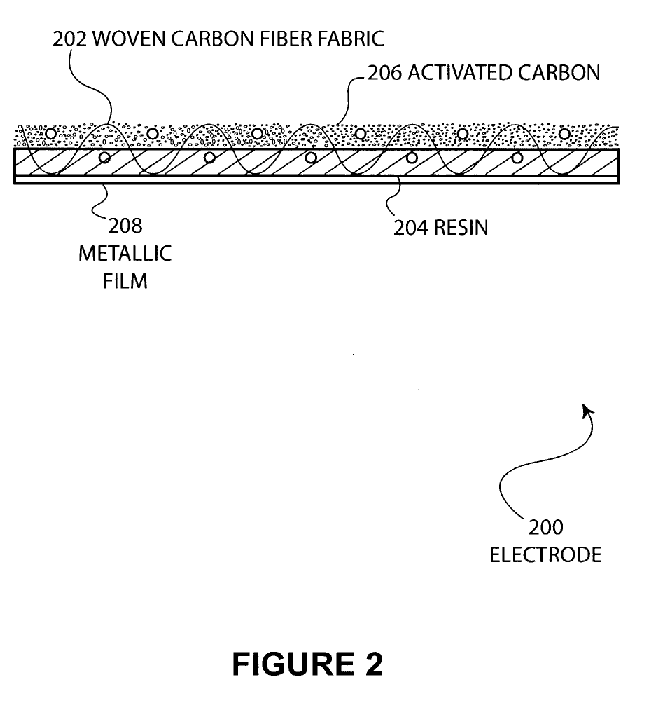

FIG. 2 illustrates a cross sectional view of an embodiment 200 of the present invention of a partially saturated carbon composite electrode. A woven carbon fiber fabric 202 is partially saturated with resin 204. Activated carbon 206 is added to the exposed portion of the fabric 202 and a metallic film 208 may be added to the resin side of the fabric 202.

The activated carbon 206 may be added to the exposed carbon fibers and may be a particulate that is bound together by a binder, such as PVDF or other binder as known in the art. The activated carbon 206 may further increase the exposed surface area of the conductive material in the electrode 202. In other embodiments, activated carbon 206 may be substituted by another material that is highly porous.

The metallic film 208 may be a film of aluminum, copper, or other conductive film that may serve as a current collector. In some embodiments, the resin impregnated side of the carbon fiber composite may serve as the current collector portion of an ultracapacitor and the metallic film 208 may thereby be omitted. Such embodiments may or may not include conductive additives to the resin 204.

In still other embodiments, a second carbon fiber panel may be fully saturated and bonded to the partially saturated fabric 202. The second carbon fiber panel may thereby act as the current collector. Such a carbon fiber panel may be non-woven or woven material and may have conductive additives in the resin. The second carbon fiber panel may be cocured with the partially saturated fabric 202 or may be separately manufactured and bonded to the partially saturated fabric 202. In some cases, the resin material may be different between the partially saturated fabric 202 and a second panel used as a current collector. Those skilled in the arts may use different combinations of materials and processes while keeping within the scope and intent of the present invention.

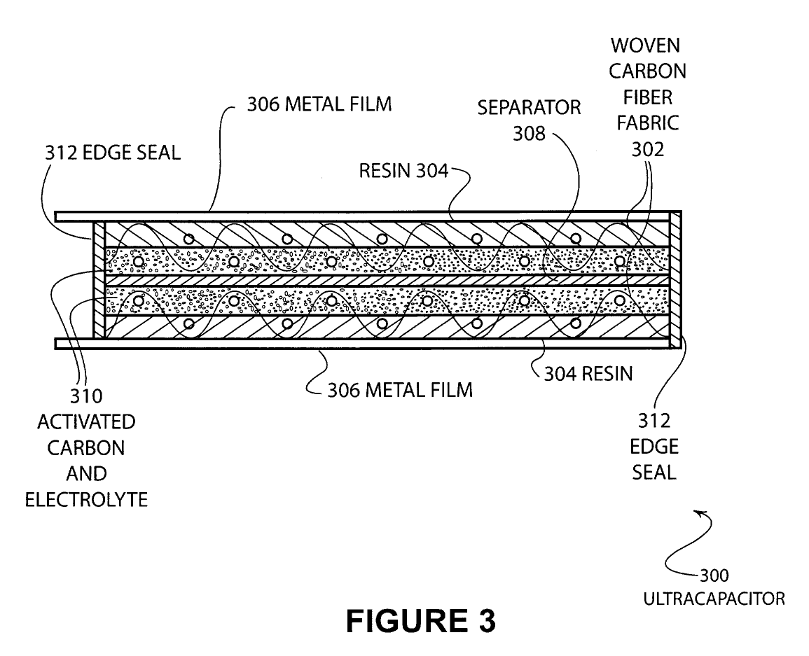

FIG. 3 illustrates a cross sectional view of an embodiment 300 of the present invention of an ultracapacitor. Two layers of woven carbon fiber fabric 302 are partially saturated with resin 304. Optional layers of metal film 306 are placed on the outer sides while a separator 308 is placed in the middle. Activated carbon and electrolyte 310 are between the separator 308 and the exposed carbon fibers of the fabric 302. Edge seals 312 are used to keep the electrolyte 310 sealed within the ultracapacitor 300.

The electrolyte 310 may be water or an organic liquid and a dissolved salt. Many salts are known in the art that would be applicable to the present invention and may be selected on their inertness and conductivity. The separator 308 may be porous and allow the electrolyte 310 to permeate the separator 308.

Voltage may be applied between the two metal film layers 306 to charge the ultracapacitor. Upon charging, ions in the electrolyte that wets the unsaturated portion of the carbon fiber fabric will be oriented at the surface to form an electrical double layer thus storing energy. The energy can be released under discharge, where the ions reorient to a less polarized orientation.

Electrical conductivity through the electrode will be enhanced by the conductivity along the carbon fibers in both the resin saturated layer and the unsaturated portion of the fabric. The fibers also enhance thermal conductivity throughout the ultracapacitor.

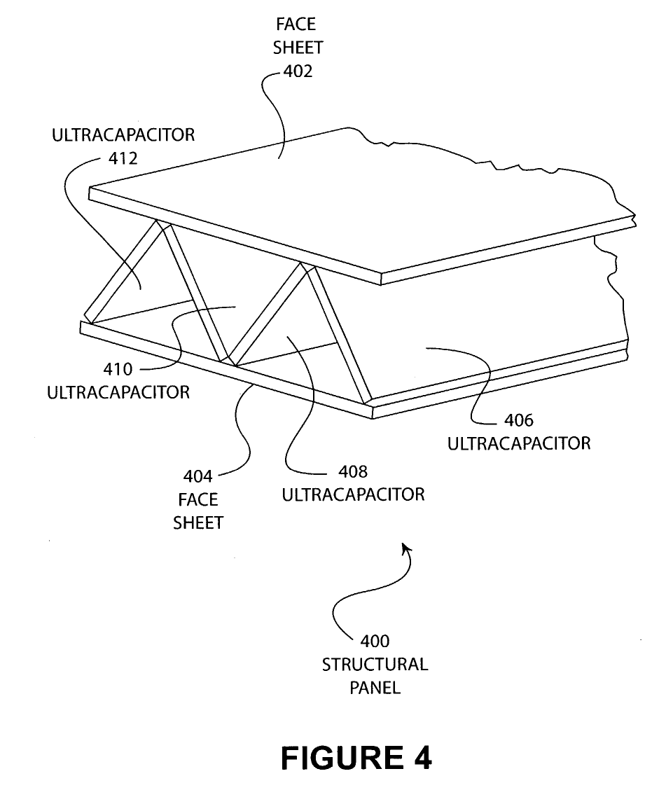

FIG. 4 illustrates an embodiment 400 of a structural element comprised of two face sheets 402 and 404 and ultracapacitors 406, 408, 410, and 412.

In the embodiment 400, the structural stiffness of the ultracapacitors 406, 408, 410, and 412 may be used as a load bearing component of the panel. The ultracapacitors may be joined to the face sheets using various methods, including bonding, fastening, cocuring, or any other method. In other embodiments, the face sheets 402 and 404 may be replaced by ultracapacitors.

In some embodiments, the open channels between the face sheets and ultracapacitors may be used to cool the ultracapacitors. For example, water, air, or other heat conducting fluid may be circulated through the channels to transfer heat away from the ultracapacitors.

By using the ultracapacitors as a structural element, the overall weight of a space vehicle or other application may be lessened. The strength and stiffness of the partially saturated carbon fiber composite electrode may be capable of handling a certain amount of structural load while still functioning as an ultracapacitor.

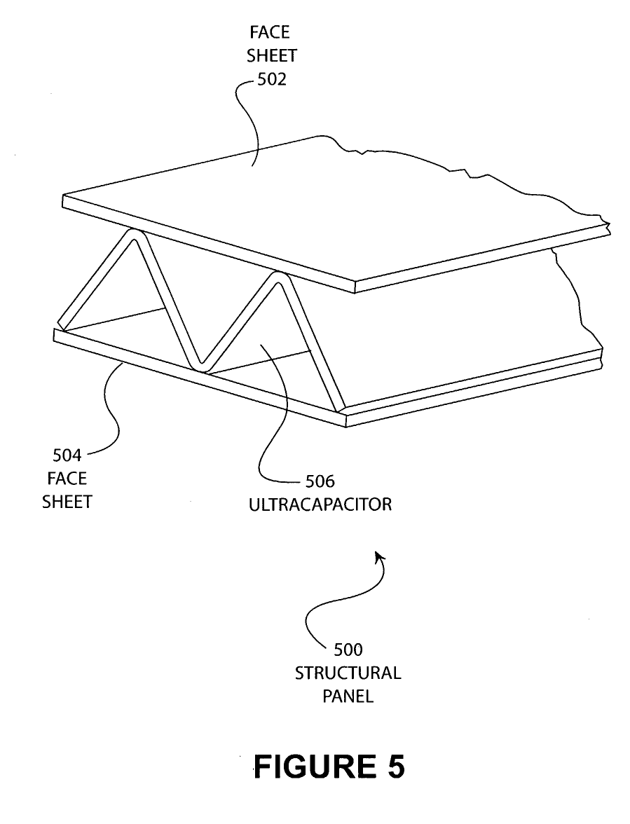

FIG. 5 illustrates an embodiment 500 of a structural panel comprised of face sheets 502 and 504 and a corrugated ultracapacitor 506. The embodiment 500 is similar in function to the embodiment 400, however the ultracapacitor 506 is a unitized piece whereas the ultracapacitors 406, 408, 410, and 412 may be individual components. The single unitized ultracapacitor 506 may be more easily assembled into the embodiment 500.

Many different structural elements may be constructed by those skilled in the art wherein an ultracapacitor panel may be integrated into a structural element. While the embodiments have been directed at flat panel construction, other shapes, such as tubular, corrugated, or curved shapes, such as airfoil or curved panels are also envisioned.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for manufacturing an electrode comprising:
providing a woven carbon fiber fabric;
saturating a portion of the thickness of said fabric to produce a saturated portion and an unsaturated portion, said saturated portion having at least some structural rigidity and said unsaturated portion having at least some exposed fibers; and
attaching an electrical conductor to said saturated portion.

2. The method of claim 1 wherein said electrical conductor comprises a metallic film that is attached across at least a portion of the surface area of said saturated portion.

3. The method of claim 1 further comprising activating at least a portion of the carbon fibers of said fabric.

4. The method of claim 3 wherein said portion of said carbon fibers of said fabric comprise at least a portion of said unsaturated portion of said fabric.

5. The method of claim 1 further comprising binding a porous material to said unsaturated portion.

6. The method of claim 5 wherein said porous material is activated carbon.

7. A method for manufacturing an ultracapacitor comprising:
providing a first woven carbon fiber fabric;
providing a second woven carbon fiber fabric;
saturating a portion of the thickness of said first fabric to produce a saturated portion and an unsaturated portion, said saturated portion having at least some structural rigidity and said unsaturated portion having at least some exposed fibers;
saturating a portion of the thickness of said second fabric to produce a saturated portion and an unsaturated portion, said saturated portion having at least some structural rigidity and said unsaturated portion having at least some exposed fibers;
providing a separator material having a first side and a second side;
placing said unsaturated portion of said first fabric against said first side of said separator material;
placing said unsaturated portion of said second fabric against said second side of said separator material;
adding an electrolyte to said unsaturated portion of said first material;
adding an electrolyte to said unsaturated portion of said second material; and
sealing said saturated portion of said first fabric to said saturated portion of said second fabric.

8. The method of claim 7 further comprising:
attaching a first electrical conductor to said saturated portion of said first fabric; and
attaching a second electrical conductor to said saturated portion of said second fabric.

9. The method of claim 8 wherein said first electrical conductor is a metallic film.

10. The method of claim 8 wherein said first electrical conductor is a carbon fiber composite.

11. The method of claim 9 wherein said first electrical conductor comprises a metallic film that is attached across at least a portion of the surface area of said saturated portion.

12. The method of claim 7 further comprising activating at least a portion of the carbon fibers of said first fabric and activating at least a portion of the carbon fibers of said second fabric.

13. The method of claim 7 further comprising binding a porous material to said unsaturated portion of said first fabric and binding a porous material to said unsaturated portion of said second fabric.

14. The method of claim 13 wherein said porous material is activated carbon.

15. An electrode manufactured by the method of:
providing a woven carbon fiber fabric;
saturating a portion of the thickness of said fabric to produce a saturated portion and an unsaturated portion, said saturated portion having at least some structural rigidity and said unsaturated portion having at least some exposed fibers; and
attaching an electrical conductor to said saturated portion.

16. An ultracapacitor manufactured by the method of:
providing a first woven carbon fiber fabric;
providing a second woven carbon fiber fabric;
saturating a portion of the thickness of said first fabric to produce a saturated portion and an unsaturated portion, said saturated portion having at least some structural rigidity and said unsaturated portion having at least some exposed fibers;
saturating a portion of the thickness of said second fabric to produce a saturated portion and an unsaturated portion, said saturated portion having at least some structural rigidity and said unsaturated portion having at least some exposed fibers;
providing a separator material having a first side and a second side;
placing said unsaturated portion of said first fabric against said first side of said separator material;
placing said unsaturated portion of said second fabric against said second side of said separator material;
adding an electrolyte to said unsaturated portion of said first material;
adding an electrolyte to said unsaturated portion of said second material; and
sealing said saturated portion of said first fabric to said saturated portion of said second fabric.

17. The ultracapacitor manufactured by the method of claim 14 further comprising:
attaching a first electrical conductor to said saturated portion of said first fabric; and
attaching a second electrical conductor to said saturated portion of said second fabric.

18. The ultracapacitor manufactured by the method of claim 17 wherein said first electrical conductor comprises a metallic film that is attached across at least a portion of the surface area of said saturated portion.

19. The ultracapacitor manufactured by the method of claim 17 further comprising activating at least a portion of the carbon fibers of said first fabric and activating at least a portion of the carbon fibers of said second fabric.

20. The ultracapacitor manufactured by the method of claim 17 further comprising binding a porous material to said unsaturated portion of said first fabric and binding a porous material to said unsaturated portion of said second fabric.

21. The ultracapacitor manufactured by the method of claim 20 wherein said porous material is activated carbon.

22. An electrode comprising:
a woven carbon fiber fabric;
a resin partially saturated into a portion of the thickness of said fabric to produce a saturated portion and an unsaturated portion, said saturated portion having at least some structural rigidity and said unsaturated portion having at least some exposed fibers; and
an electrical conductor attached to said saturated portion.

23. The electrode of claim 22 wherein said electrical conductor comprises a metallic film that is attached across at least a portion of the surface area of said saturated portion.

24. The electrode of claim 22 wherein at least a portion of the carbon fibers of said fabric is activated.

25. The electrode of claim 24 wherein said portion of said carbon fibers of said fabric comprise at least a portion of said unsaturated portion of said fabric.

26. The electrode of claim 22 further comprising a porous material bound to said unsaturated portion.

27. The electrode of claim 26 wherein said porous material is activated carbon.

28. An ultracapacitor comprising:
a first woven carbon fiber fabric;
a second woven carbon fiber fabric;
a resin partially saturated into a portion of the thickness of said first fabric to produce a saturated portion and an unsaturated portion, said saturated portion having at least some structural rigidity and said unsaturated portion having at least some exposed fibers, said resin further partially saturating a portion of the thickness of said second fabric to produce a saturated portion and an unsaturated portion, said saturated portion having at least some structural rigidity and said unsaturated portion having at least some exposed fibers;
a first electrical conductor attached to said saturated portion of said first fabric;
a second electrical conductor attached to said saturated portion of said second fabric;
a separator material having a first side and a second side, said unsaturated portion of said first fabric being against said first side of said separator material and said unsaturated portion of said second fabric against said second side of said separator material;
an electrolyte saturating said unsaturated portion of said first material and saturating said unsaturated portion of said second material; and
a sealant sealing said saturated portion of said first fabric to said saturated portion of said second fabric.

29. The ultracapacitor of claim 28 further comprising:
a first electrical conductor attached to said saturated portion of said first fabric; and
a second electrical conductor attached to said saturated portion of said second fabric.

30. The ultracapacitor of claim 28 wherein said first electrical conductor comprises a metallic film that is attached across at least a portion of the surface area of said saturated portion.

31. The ultracapacitor of claim 28 wherein at least a portion of the carbon fibers of said first fabric is activated and at least a portion of the carbon fibers of said second fabric is activated.

32. The ultracapacitor of claim 28 further comprising a first portion of porous material bound to said unsaturated portion of said first fabric and a second portion of said porous material is bound to said unsaturated portion of said second fabric.

33. The ultracapacitor of claim 32 wherein said porous material is activated carbon.
